(19) United States
(12) Patent Application Publication
(10) Pub. No.: US 2009/0216650 A1
(43) Pub. Date: Aug. 27, 2009

(54) Cyber Pub (CP)

(76) Inventor: Americo Salas Peralta, Cusco (PE)

Correspondence Address: DEFILLO & ASSOCIATES, INC., P.O. Box 14104, Clearwater, FL, 33766, US

(21) Appl. No.: 12/070,757

(22) Filed: Feb. 21, 2008

(51) Int. Cl. G06Q 30/00

(52) U.S. Cl. 705/15

(57) ABSTRACT

The present invention relates to a Cyber-Pub (CP) that allows an easy social interchange among people. More specifically, the present invention relates to a system and method that allows the social interchange amongst people who suffer from difficulties related to shyness.

### FIELD OF THE INVENTION

The present invention relates to a Cyber-Pub (CP) that allows an easy social interchange among people. More specifically, the present invention relates to a system and method that allows the social interchange amongst people who suffer from difficulties related to shyness.

### BACKGROUND OF THE INVENTION

Considering that shyness is one of the most complicated emotional states that affect the universe of personal relationships, leading to a sensation of insecurity or shame of oneself when facing new social situations, and making it difficult to establish a conversation and to get involved with other people.

The present inventor thought of the necessity of providing a system that helps people who have trouble interacting with other people the opportunity to socially interact with others.

The major goal of the present invention is to create an appropriate environment for social interchange and also to supply the requirements in a casual way, to achieve it, like a bar or up-to-date music which allows the desired danceable enjoyment.

Although, at some moment, several ideas to create social interaction among unknown people were proposed, such as places (locations) that propose especial distinctions under a pre-established code like visual symbols about the customer's condition, it has never been proposed the possibility to use informatics' technologic developments for this purpose in the way shown in this project.

### SUMMARY OF THE INVENTION

The system of the present invention helps a person establish a social relationship with other people. The system comprises:
a closed place comprising:
a) a bar,
b) sound equipment,
c) a kitchen,
d) a dance floor,
e) restrooms,
f) optionally a wardroom;
g) a central meeting room;
h) at least two private rooms, wherein each private room includes furniture, an illumination system, a computer, and a web cam, wherein each rooms is numbered;
i) a central computer, wherein the central computer controls and communicates with the computer of each private room by an internal communication program or internal e-mail;

wherein the computer in each room is able to communicate with the computer in the other rooms;

wherein the system allows to establish a non-physical personal contact with other people by using the computer in each private room;

wherein the system has a fully automatic service, wherein the fully automatic service uses the connection between the computer and the computer in each private room to allow the person to request drinks, food, music, or pay bills without leaving the private room;

wherein the central computer is operated by an operator who is responsible for processing the request of the person in the private room;

wherein the computer in each private room includes a special computer program tailored to allow the person to choose from a menu that allows communication with at least one of the central computers or with the computer in any other private room and sub-menus that allows the user to choose the type of communication desired;

wherein after communicating with other people the person in each private room decides if he/she will personally meet with other people;

wherein if the person decides to personally meet other people, they can meet at the dance floor or the central meeting room.

The communication between the central computer and the computer in each private room may be a wireless communication.

Furthermore, the present invention contemplates a method for helping a person establish a social relationship with other people, the method comprising the steps of:
1) providing a closed place comprising:

a bar,

sound equipment,

a kitchen,

a dance floor,

restrooms,

optionally a wardroom;

a central meeting room;

at least two private rooms, wherein each private room includes furniture, an illumination system, a computer, and a web cam, wherein each rooms is numbered;

a central computer, wherein the central computer controls and communicates with the computer of each private room by an internal communication program or internal e-mail; wherein the computer in each room is able to communicate with the computer in the other rooms;

wherein the system has a fully automatic service, wherein the fully automatic service uses the connection between the computer and the computer in each private room to allow the person to request drinks, food, music, or pay bills without leaving the private room;

wherein the central computer is operated by an operator who is responsible for processing the request of the person in the private room;

wherein the computer in each private room includes a special computer program tailored to allow the person to choose from a menu that allows communication with at least one of the central computers or with the computer on any other private room and sub-menus that allows the user to choose the type of communication desired;
2) establishing a non-physical personal contact between the person and other people by using the computer in each private room;
3) deciding after communicating with other people if interested in personally meeting the other people;
4) optionally personally meeting at the dance floor or the central meeting room.

The present invention (Cyber Pub (CP)) is an enterprise that aims for an easy social interchange among people, especially amongst people who suffer from difficulties related to shyness.

That's why the Cyber Pub (CP) includes all the equipment of a discotheque, such as a bar, sound equipment, a kitchen, tools and a dance floor, with the difference being that the Cyber Pub includes private rooms for the customers.

Each private room includes normal furniture such as chairs and tables, a computerized connection system that connects the private rooms and a central control computer using computer screens, keyboards, a web cam, and a computer in each private room. This means that the central computer and the private rooms are connected with an internal e-mail system.

This allows the customers the opportunity to establish an initial contact using the internal communication system before a direct personal communication, which eventually could not be positive.

Each private room has a video cam or web cam for present time image transmission and internet connection.

All the Cyber Pub's management is automatic, which enables that every service request from the private room to the central computer made using the keyboards placed in the rooms, will be satisfied the same as musical requests or the request for the check. The central program is already built and is included on a project's exposition appendix.

### BRIEF DESCRIPTION OF THE DRAWINGS

FIG. 1 outlines a top view of the cyber pub according to the present invention.

### DETAILED DESCRIPTION OF THE INVENTION

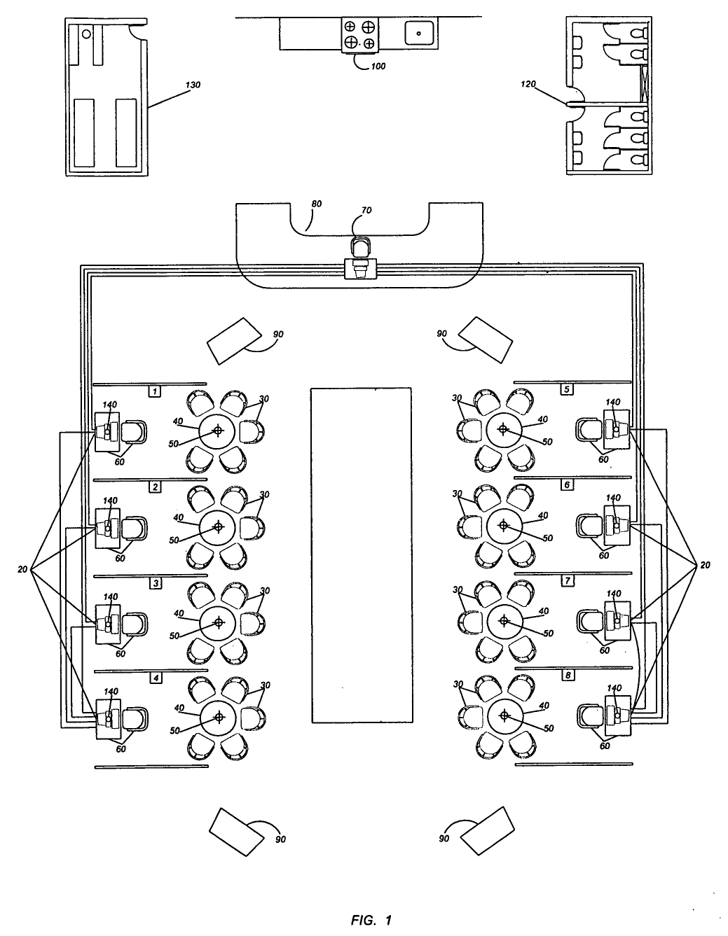

The present invention, Cyber Pub (CP) 10 (FIG. 1), is an enterprise that aims for helping people who experience some level of shyness and that want to establish social relationships with new people.

That's why the CP is installed in a closed area that includes private rooms 20 opened for customers' attention. Every private room has chairs 30, tables 40, an illumination system 50, a computer screen and a keyboard 60.

A central computer 70 is connected to each private room by an internal communication program or internal e-mail, as well as each private room is connected with the other rooms. This way, one person or a group of people, that will be using a private room, will be able to communicate with any other private room or with the central computer.

This gives the customer the opportunity to establish contact with other customers by using the internal e-mail, so that by having a dialog or a previous conversation, the possibility allows for direct personal social contact if desired. Additionally, the CP has a bar 80, sound equipment 90, a kitchen 100, a dance floor 110, restrooms 120, and wardroom 130.

The CP is a fully automatic service created using the informatics, so that every service request for cocktails, dishes or snacks, music, consumer register or just for the bill is made with the help of the terminal located in each private room and is registered by the central computer automatically.

The terminal of each private room has a video cam or web cam 140 for real time images transmission and it also has internet connection. The CP has a large digitalized musical file that facilitates the search for titles or artists.

The internet connection usage will also be registered and rated by the central program. This program organizes the requirements attention sequence considering the arrival time, as for the service request for private rooms or for the service of paying the check by the time the customer leaves the CP.

By accessing the screen available in his private room, the customer will see a menu that proposes the options to communicate with the central computer or with any other private room. As long as every private room is numbered, it will be easy to select the one with which the customer wants to communicate.

If the customer chooses to communicate with the central computer, a sub-menu will appear which will show the options to choose between a service request, music request, or bill request. If the customer chooses to request service, the food and drink options will be displayed so that he could select his requirements.

If the customer chooses to request music, the entire available music file, which allows the option to find a specific song through searching for the artist or the title of the song desired, will be shown. Once the desired service selection is realized, the customer will send his petition to the central computer in a written message sent by the internal e-mail. The central computer will be handled by an operator who will be responsible for processing the petitions according to the case.

The whole procedure is controlled by an especially elaborated program for the purpose. The schema of ties is shown in the enclosed drawing.

1-6. (canceled)

7. A system to facilitate a social interchange among users, the system comprising:
an enclosed space comprising inside:
a bar
sound equipments;
a kitchen;
a dance floor;
restrooms;
optionally a wardroom;
a central meeting room;
at least two private rooms, wherein the private rooms are located inside the same enclosed space, wherein each private room includes furniture, an illumination system, a computer, and a web cam, wherein each user is accommodated in one of the private rooms;
a central computer operated by an operator, wherein the central computer communicates with the computers of each private room;
wherein the user in one of the private rooms at the beginning of the communication does not personally know the user of the other private room;
wherein the private rooms are placed around the dance floor;
wherein all the communications are internal communications between the computers inside the enclosed space;
wherein the user in each private room communicates with the user in another private room by using the computer in each private room;
wherein the user in each private room may request drinks, food, music, or pay the bill by using the computer in each private room without leaving the private room;
wherein the operator is responsible for processing the request of the users in each of the private rooms;
wherein the user in one of the private rooms establishes an initial contact with the user in another private room, wherein the initial contact is a non-physical and non-visual communication with the other user by using the computer in each private room;
wherein a physical and visual contact is performed by the users after the initial contact if the users decided to meet;
wherein the physical and visual contact takes place at the dance floor, the central meeting room, or one of the private rooms;
wherein the social interchange among users takes place internally inside the enclosed space and there is no communication outside the enclosed space.

8. The system of claim 7 wherein the user in a private room further communicates with the user in another private room by using the web cams in each private room.

9. The system of claim 7 wherein the central computer and the private room computers are connected with an internal e-mail system.

10. The system of claim 7 further comprising a digitalized musical system that facilitates the search for titles or artists.

11. The system of claim 7 wherein the computer in each private room is a laptop.

12. The system of claim 7 wherein the communication between the central computer and the computer in each private room is a wireless communication.

13. The system of claim 7 wherein each private room has its own musical system, independent from the musical system of the other private rooms.

14. A system to facilitate a social interchange among users, the system consisting of:
an enclosed space containing inside:
a bar;
sound equipments;
a kitchen;
a dance floor;
restrooms;
optionally a wardroom;
a central meeting room;
at least two private rooms, wherein the private rooms are located inside the same enclosed space, wherein each private room includes furniture, an illumination system, a computer, and a web cam, wherein each user is accommodated in one of the private rooms;
a central computer operated by an operator, wherein the central computer communicates with the computers of each private room;
wherein all the communications are internal communications between the computers inside the enclosed space;
wherein the user in each private room communicates with the user in another private room by using the computer in each private room;
wherein the user in each private room may request drinks, food, music, or pay the bill by using the computer in each private room without leaving the private room;
wherein the operator is responsible for processing the request of the users in each of the private rooms;
wherein the user in one of the private rooms establishes an initial contact with the user in another private room, wherein the initial contact is a non-physical and non- visual communication with the other user by using the computer in each private room;
wherein a physical and visual contact is performed by the users after the initial contact if the users decided to meet;
wherein the physical and visual contact takes place at the dance floor, the central meeting room, or one of the private rooms;
wherein the social interchange among users takes place internally inside the enclosed space and there is no communication outside the enclosed space.

15. A method for facilitating a social interchange among users, the method comprising the steps of:
1) providing an enclosed space comprising inside:
a bar
sound equipments;
a kitchen;
a dance floor;
restrooms;
optionally a wardroom;
a central meeting room;
at least two private rooms, wherein each private room includes furniture, an illumination system, a computer, and a web cam, wherein each user is accommodated in one of the private rooms;
a central computer operated by an operator, wherein the central computer controls and communicates with the computers of each private room;
wherein the computer in each private room also communicates with the computer in another private room;
wherein all the communications are internal communications between the computers inside the enclosed space;
wherein the user in each private room communicates with the user of another private room by using the computer in each private room;
wherein the user in each private room may request drinks, food, music, or pay the bill by using the computer in each private room without leaving the private room;
wherein the operator is responsible for processing the request of the users in each of the private rooms;
2) conducting an initial contact between the users of a private room with the user of another private room, wherein the user in one of the private rooms at the beginning of the communication does not personally know the user of the other private room, wherein the initial contact is a non-physical and non-visual communication by using the computer in each private room;
3) optionally conducting a visual contact between the user of a private room with the other user by using the web cams in each private room;
4) conducting a physical and visual contact between the user of a private room with the user of another private room at the dance floor, the central meeting room, or one of the private rooms; and
wherein the social interchange among users takes place internally inside the enclosed space.
